(19) United States
(12) Patent Application Publication
(10) Pub. No.: US 2021/0357620 A1
(43) Pub. Date: Nov. 18, 2021

(54) SYSTEM, MOVING OBJECT, AND INFORMATION PROCESSING APPARATUS

(71) Applicant: TOYOTA JIDOSHA KABUSHIKI KAISHA, Toyota-shi (JP)

(72) Inventors: Wataru KYOCHIKA, Toyota-shi (JP); Riho MATSUO, Nagoya-shi (JP); Kenta MIYAHARA, Toyota-shi (JP); Ryotaro KAKIHARA, Nagoya-shi (JP)

(73) Assignee: TOYOTA JIDOSHA KABUSHIKI KAISHA, Toyota-shi (JP)

(21) Appl. No.: 17/243,849

(22) Filed: Apr. 29, 2021

(30) Foreign Application Priority Data
May 12, 2020 (JP) 2020-083846

(51) Int. Cl. G06K 9/00; H04L 29/08; B64C 39/02

(52) U.S. Cl. CPC G06K 9/0063; H04L 67/06; B64C 2201/127; B64C 2201/123; B64C 39/024

(57) ABSTRACT

A moving object includes: an imaging device configured to take images of surroundings of the moving object that moves autonomously; a storage unit configured to store a reference image, which is an image taken at an imaging position in a predetermined area; and a controller configured to transmit, to a server, a first image that is an image taken by the imaging device at the imaging position and that is different by a predetermined value or more from the reference image, and information on the position at which the first image has been taken. The server is configured to determine, based on the first image received, a situation of damage in the predetermined area.

### CROSS REFERENCE TO THE RELATED APPLICATION

This application claims the benefit of Japanese Patent Application No. 2020-083846, filed on May 12, 2020, which is hereby incorporated by reference herein in its entirety.

### BACKGROUND

### Technical Field

The present disclosure relates to a system, a moving object, and an information processing apparatus.

### Description of the Related Art

There have been known technologies for grasping the growth conditions of crops by using drones (for example, see Patent Literature 1).

### CITATION LIST

### Patent Literature

Patent Literature 1: PCT International Publication No. 2018/168565

### SUMMARY

The object of this disclosure is to provide a technology that allows an autonomous moving object to be better utilized in times of disaster.

One aspect of the present disclosure is directed to a system comprising:
a moving object configured to move autonomously; and
a server;
the moving object including:
   an imaging device configured to take images of surroundings of the moving object that moves autonomously;
   a storage unit configured to store a reference image, which is an image taken at an imaging position in a predetermined area; and
   a controller configured to transmit, to a server, a first image that is an image taken by the imaging device at the imaging position and that is different by a predetermined value or more from the reference image, and information on the position at which the first image has been taken; and
the server being configured to determine, based on the first image thus received, a situation of damage in the predetermined area.

Another aspect of the present disclosure is directed to a moving object comprising:
an imaging device configured to image surroundings of the autonomously moving object;
a storage unit configured to store a reference image, which is an image taken at an imaging position in a predetermined area; and
a controller configured to perform transmitting, to a server, a first image that is an image taken by the imaging device at the imaging position and that is different by a predetermined value or more from the reference image, and information on the position at which the first image has been taken.

A further aspect of the present disclosure is directed to an information processing apparatus including a controller configured to perform:

receiving a first image that is an image taken by an autonomously moving object at the same position as a reference image that is an image taken at an imaging position in a predetermined area, and that is different by a predetermined value from the reference image, and information on the position at which the first image has been taken; and

determining, based on the first image thus received, a situation of damage in the predetermined area.

A still further aspect of the present disclosure is directed to an information processing method for causing a computer to execute processing in the system, the moving object or the information processing apparatus. In addition, a yet further aspect of the present disclosure is directed to a program that causes a computer to execute processing in the system, the moving object or the information processing apparatus, or is also directed a storage medium that stores the program in a non-transitory manner.

According to the present disclosure, it is possible to provide a technology for enabling an autonomous moving object to be better utilized in times of disaster.

### BRIEF DESCRIPTION OF THE DRAWINGS

FIG. 1 is a diagram illustrating a schematic configuration of a system according to an embodiment;

FIG. 2 is a block diagram schematically illustrating an example of a configuration of each of a drone, a user terminal, and a center server included in the system according to the embodiment;

FIG. 3 is a diagram illustrating a functional configuration of the drone;

FIG. 4 is a diagram illustrating an example of a table configuration of reference image information;

FIG. 5 is a diagram illustrating an example of a functional configuration of the center server;

FIG. 6 is a diagram illustrating an example of a table configuration of a disaster area DB;

FIG. 7 is a diagram illustrating an example of a functional configuration of the user terminal;

FIG. 8 is a sequence diagram of the processing of the system;

FIG. 9 is a flowchart of imaging processing according to the embodiment;

FIG. 10 is a flowchart of command generation processing according to the embodiment; and

FIG. 11 is a flowchart of determination processing according to the embodiment.

### DESCRIPTION OF THE EMBODIMENTS

A moving object included in a system, which is one aspect of the present disclosure, is an autonomously moving object. The moving object is, for example, a vehicle or a drone. The moving object includes an imaging device for taking pictures or images of the surroundings thereof. The images are taken by the imaging device so that a situation of damage caused by the occurrence of a disaster can be grasped. In addition, the moving object includes a storage unit that stores a reference image. The reference image is a taken image, and is also an image before a disaster occurs. There may be a plurality of reference images corresponding to a plurality of positions. Each reference image is, for example, an image taken in the past at an imaging position. The moving object may obtain a reference image by taking a picture or image by means of the imaging device in advance.

In addition, the moving object includes a controller. The controller transmits a first image and an imaging position thereof to a server. The first image is an image having a predetermined value or more in comparison with the reference image. Here, in cases where a difference between the taken reference image and a freshly taken image is more than a predetermined value, it can be determined that a disaster has occurred at the location taken in the freshly taken image. The image to be compared with the reference image is, for example, an image freshly taken in the same position and orientation as the position and orientation in which the reference image has been taken. By transmitting the first image and the imaging position to the server, the server can grasp the occurrence of the disaster. For example, the moving object autonomously moves around a plurality of imaging positions to take images, and compares each taken image with a reference image corresponding to each imaging position. Each imaging position may be a position associated with a place where a disaster has occurred in the past. The moving object may take pictures or images when the moving object or the server detects a situation in which a disaster occurs.

The server determines, based on the first image, the situation of damage caused by a disaster that has occurred in the predetermined area. At this time, the server may determine the degree of the damage or classify the type of the damage. The server determines the situation of the damage in the predetermined area, for example, by performing an image analysis of the first image. The server may transmit the information, for example, to a user terminal based on the damage situation thus determined.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

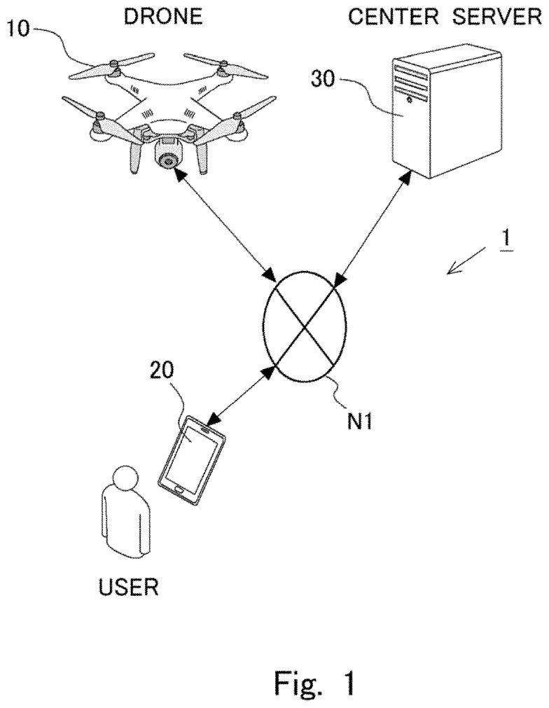

FIG. 1 is a diagram illustrating a schematic configuration of a system 1 according to the present embodiment. The system 1 serves to provide information on a damage situation to a user based on images taken by a drone 10 in a predetermined area after the occurrence of a disaster. The drone 10 is an example of a moving object.

In the example of FIG. 1, the system 1 includes the drone 10, a user terminal 20, and a center server 30. The drone 10, the user terminal 20, and the center server 30 are connected to one another by means of a network N1. The drone 10 is capable of moving autonomously. The user terminal 20 is a terminal that is used by a user.

The network N1 is, for example, a worldwide public communication network such as the Internet, and a WAN (Wide Area Network) or other communication networks may be adopted. In addition, the network N1 may include a telephone communication network such as a mobile phone network, or a wireless communication network such as Wi-Fi (registered trademark). Here, note that FIG. 1 illustrates one drone 10 and one user terminal 20 by way of example, but there can be a plurality of drones 10 and a plurality of user terminals 20.

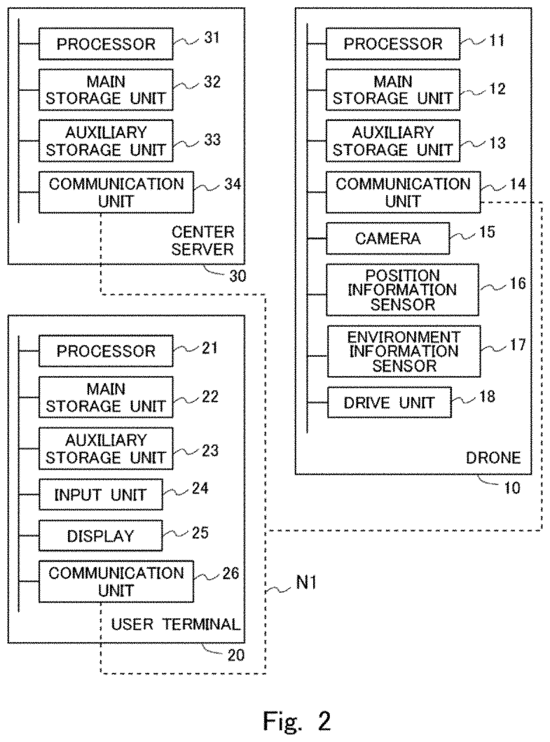

Hardware and functional configurations of the drone 10, the user terminal 20, and the center server 30 will be described based on FIG. 2. FIG. 2 is a block diagram schematically illustrating an example of a configuration of each of the drone 10, the user terminal 20 and the center server 30, which together constitute the system 1 according to the present embodiment.

The center server 30 has a configuration of a general computer. The center server 30 includes a processor 31, a main storage unit 32, an auxiliary storage unit 33, and a communication unit 34. These components are connected to one another by means of a bus. The processor 31 is an example of a controller.

The processor 31 is a CPU (Central Processing Unit), a DSP (Digital Signal Processor), or the like. The processor 31 controls the center server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads the programs stored in the auxiliary storage unit 33 into a work area of the main storage unit 32 and executes the programs, so that each of the component units and the like is controlled through the execution of the programs. Thus, the center server 30 realizes functions matching predetermined purposes, respectively. The main storage unit 32 and the auxiliary storage unit 33 are computer-readable recording media. Here, note that the center server 30 may be a single computer or a combination of a plurality of computers. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the drone 10 and the user terminal 20 via the network N1. The communication unit 34 is, for example, a LAN (Local Area Network) interface board, a wireless communication circuit for wireless communication, or the like. The LAN interface board or the wireless communication circuit is connected to the network N1.

Now, the drone 10 is a moving object capable of flying autonomously, and includes a computer. The drone 10 is, for example, a multicopter. The drone 10 includes a processor 11, a main storage unit 12, an auxiliary storage unit 13, a communication unit 14, a camera 15, a position information sensor 16, an environment information sensor 17, and a drive unit 18. These components are connected to one another by means of a bus. The processor 11, the main storage unit 12, and the auxiliary storage unit 13 are the same as the processor 31, the main storage unit 32, and the auxiliary storage unit 33 of the center server 30, respectively, and hence, the description thereof will be omitted. The processor 11 is an example of a control unit. In addition, the camera 15 is an example of an imaging device.

The communication unit 14 is a communication means for connecting the drone 10 to the network N1. The communication unit 14 is a circuit for communicating with other devices (e.g., the user terminal 20, the center server 30 or the like) via the network N1 by making use of a mobile communication service (e.g., a telephone communication network such as 5G (5th Generation), 4G (4th Generation), 3G (3rd Generation), LTE (Long Term Evolution) or the like), or wireless communication such as Wi-Fi (registered trademark), Bluetooth (registered trademark) or the like.

The camera 15 is a device that takes pictures or images of the surroundings of the drone 10. The camera 15 takes images by using an imaging element such as a CCD (Charge Coupled Device) image sensor, a CMOS (Complementary Metal Oxide Semiconductor) image sensor or the like. The images thus obtained by taking images may be either still images or moving images.

The position information sensor 16 obtains position information (e.g., latitude and longitude) of the drone 10 at predetermined intervals. The position information sensor 16 is, for example, a GPS (Global Positioning System) receiver unit, a wireless communication unit or the like. The information obtained by the position information sensor 16 is recorded in, for example, the auxiliary storage unit 13 or the like, and transmitted to the center server 30.

The environment information sensor 17 is a means or unit for sensing the state of the drone 10 or sensing the surroundings of the drone 10. Examples of the sensor for sensing the state of the drone 10 include a gyro sensor, an acceleration sensor, and an azimuth sensor. Examples of the sensor for sensing the surroundings of the drone 10 include a stereo camera, a laser scanner, a LIDAR, a radar and so on. The camera 15 can also be used as the environment information sensor 17. The data obtained by the environment information sensor 17 is also referred to as “environmental data”.

The drive unit 18 is a device for flying the drone 10 based on a control command generated by the processor 11. The drive unit 18 is configured to include, for example, a plurality of motors, etc., for driving rotors included in the drone 10, so that the plurality of motors, etc., are driven in accordance with the control command, thereby to achieve the autonomous flight of the drone 10.

Next, the user terminal 20 will be described. The user terminal 20 is a smartphone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, and a communication unit 26. These components are connected to one another by means of a bus. The processor 21, the main storage unit 22 and the auxiliary storage unit 23 are the same as the processor 31, the main storage unit 32 and the auxiliary storage unit 33 of the center server 30, respectively, and hence, the description thereof will be omitted.

The input unit 24 is a means or unit for receiving an input operation performed by a user, and is, for example, a touch panel, a mouse, a keyboard, a push button, or the like. The display 25 is a means or unit for presenting information to the user, and is, for example, an LCD (Liquid Crystal Display), an EL (Electroluminescence) panel, or the like. The input unit 24 and the display 25 may be configured as a single touch panel display. The communication unit 26 is a communication means or unit for connecting the user terminal 20 to the network N1. The communication unit 26 is a circuit for communicating with other devices (e.g., the drone 10, the center server 30 or the like) via the network N1 by making use of a mobile communication service (e.g., a telephone communication network such as 5G (5th Generation), 4G (4th Generation), 3G (3rd Generation), LTE (Long Term Evolution) or the like), or a wireless communication network such as Wi-Fi (registered trademark), Bluetooth (registered trademark) or the like.

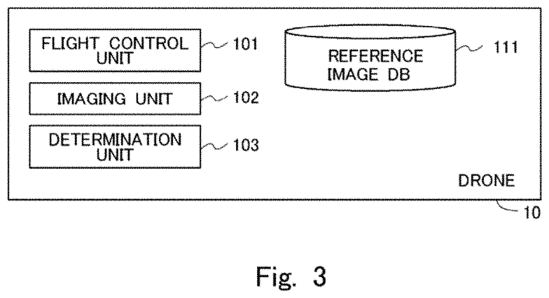

Then, the functions of the drone 10 will be described. FIG. 3 is a diagram illustrating a functional configuration of the drone 10. The drone 10 includes, as its functional components, a flight control unit 101, an imaging unit 102, a determination unit 103, and a reference image DB 111. The processor 11 of the drone 10 executes the processing of the flight control unit 101, the imaging unit 102 and the determination unit 103 by means of a computer program on the main storage unit 12. However, any of the individual functional components or a part of the processing thereof may be implemented by a hardware circuit.

The reference image DB 111 is built by a program of a database management system (DBMS) that is executed by the processor 11 to manage data stored in the auxiliary storage unit 13. The reference image DB 111 is, for example, a relational database.

Here, note that any of the individual functional components of the drone 10 or a part of the processing thereof may be implemented by another or other computers connected to the network N1.

The flight control unit 101 controls the drone 10 during the autonomous flight of the drone 10. The flight control unit 101 generates a control command for controlling the drive unit 18 by using the environmental data detected by the environment information sensor 17. For example, the flight control unit 101 controls the plurality of motors to generate differences in the rotation speeds of the plurality of rotors, thereby controlling the ascent, descent, forward movement, backward movement, turning, etc., of the drone 10.

The flight control unit 101 generates, for example, a flight trajectory of the drone 10 based on the environmental data, and controls the drive unit 18 so that the drone 10 flies along the flight trajectory. Here, note that as a method of causing the drone 10 to fly in an autonomous manner, there can be adopted a known method. The flight control unit 101 may perform feedback control based on a detected value of the environment information sensor 17 during the autonomous flight of the drone 10. The flight control unit 101 operates to control the drone 10 so as to autonomously fly around a plurality of predetermined imaging positions. The imaging positions are determined based on information on the positions stored in a position field of the reference image DB 111, which will be described later. The imaging positions may be transmitted, for example, from the user terminal 20 or the center server 30. Here, note that the flight control unit 101 may generate a flight route according to the imaging positions, but alternatively, the user terminal 20 or the center server 30 may generate a flight route. Then, the flight control unit 101 may control the drive unit 18 so that the drone 10 flies along the flight route thus generated.

The imaging unit 102 performs imaging with the camera 15 at predetermined timing. For example, when the drone 10 arrives at each imaging position, the imaging unit 102 performs imaging with the camera 15, and stores images in the auxiliary storage unit 13. In this embodiment, it is assumed that a target area (predetermined area) to be imaged has been divided into a plurality of meshes in advance. The target area is set as an area in which a disaster may occur. Each mesh is determined so as to be included in one image taken by the camera 15, for example. Then, imaging is performed, for example, for each of the plurality of meshes included in the target area. Here, note that the target area may have been determined in advance as an area to be imaged by the drone 10. In addition, the imaging positions may also be determined in advance. Moreover, the imaging positions may each be a place where a disaster has occurred in the past. Further, the imaging positions may be limited to the places where there are houses or roads. The information on each imaging position can include information on the altitude of the drone 10 and the orientation of the camera 15 at the time of imaging. Note that the orientation of the camera 15 at the time of imaging may be always the same.

In addition, the imaging unit 102 takes reference images. The reference images are taken when no disaster occurs. In the case of taking an image at an imaging position when a disaster does not occur, the imaging unit 102 stores the image thus taken in the reference image DB 111 as a reference image. The reference image may be updated at a predetermined cycle.

The determination unit 103 compares an image taken by the imaging unit 102 at an imaging position, with a reference image that has been taken at the same imaging position in the past (which may be before the occurrence of a disaster), and transmits the image to the center server 30 together with its position information in cases where a difference between the two images is equal to or greater than a predetermined value. This predetermined value is set as a difference between the image in the case of being damaged by the disaster and the reference image. The comparison of the images can be performed, for example, by comparing feature amounts (colors or the like) of the images, but is not limited thereto. Here, note that in cases where there is no predetermined difference between the two images, the determination unit 103 may store the image taken by the imaging unit 102 as a reference image in the reference image DB 111.

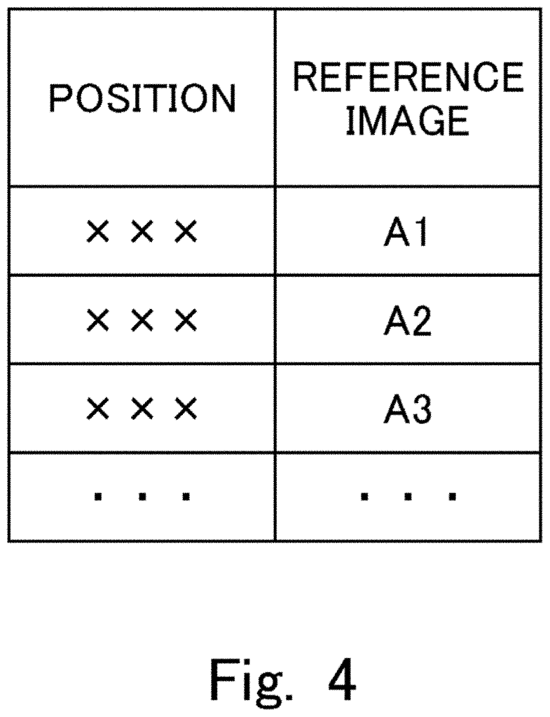

The structure of reference image information stored in the reference image DB 111 will be described based on FIG. 4. FIG. 4 is a diagram illustrating an example of a table configuration of the reference image information. A reference image information table has fields of position and reference image. In the position field, information on each position at which an image has been taken is entered. In the position field, for example, coordinates or a mesh code is entered. The position field may include, for example, information on the orientation of the camera 15 at the time of imaging. The information entered into the position field may be received, for example, from the user terminal 20 or the center server 30. Information on each reference image is entered into the reference image field. In the reference image field, for example, information on a feature amount of each reference image or information on a storage location of each reference image may be entered.

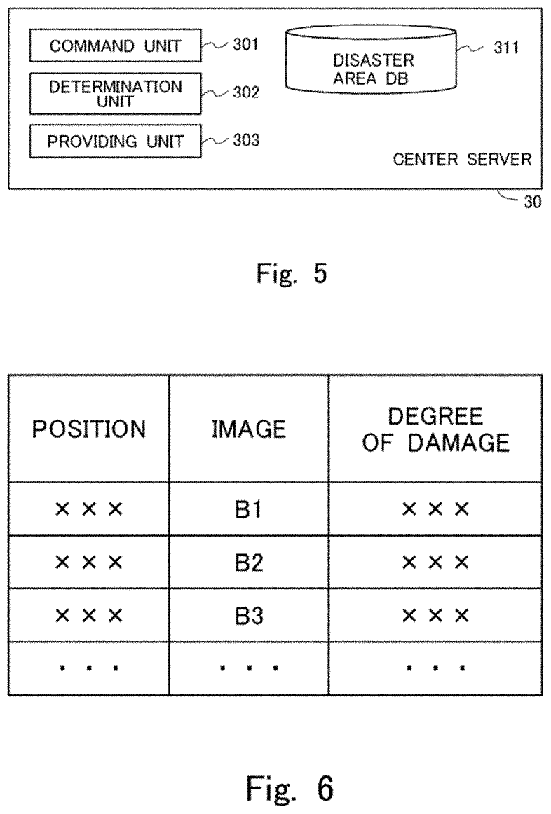

Next, the functions of the center server 30 will be described. FIG. 5 is a diagram illustrating an example of a functional configuration of the center server 30. The center server 30 includes, as its functional components, a command unit 301, a determination unit 302, a providing unit 303, and a disaster area DB 311. The processor 31 of the center server 30 executes the processing of the command unit 301, the determination unit 302 and the providing unit 303 by means of a computer program on the main storage unit 32. However, any of the individual functional components or a part of the processing thereof may be implemented by a hardware circuit.

The disaster area DB 311 is built by a program of a database management system (DBMS) that is executed by the processor 31 to manage data stored in the auxiliary storage unit 33. The disaster area DB 311 is, for example, a relational database.

Here, note that any of the individual functional components of the center server 30 or a part of the processing thereof may be implemented by another or other computers connected to the network N1.

The command unit 301 generates a flight command in a situation where a disaster may occur (e.g., in the event of an earthquake of a predetermined seismic intensity or higher, a predetermined amount or more of rainfall, a wind blow at a predetermined wind speed or higher, or a typhoon approaching within a predetermined distance). The flight command is generated such that an area in which a disaster may occur is set as a predetermined area and the drone 10 flies through each imaging position in the predetermined area. Whether or not a disaster may occur is determined based on, for example, information obtained from a server that provides weather information.

The determination unit 302 determines the degree of damage based on an image received from the drone 10. The determination unit 302 determines the degree of damage by using, for example, an image analysis. The degree of damage may be classified into 10 levels, for example. In addition, the degree of damage in the case of houses may be classified as half destruction, full destruction or the like. Also, the degree of damage in the case of roads may be classified as one side lane impassable or both side lanes impassable. Further, the determination unit 302 may determine, for example, whether or not a landslide has occurred or whether or not a flood has occurred. The determination unit 302 stores the degree of damage thus determined, the position or location of a disaster area, and the image of the disaster area in the disaster area DB 311, which will be described later. The position of the disaster area may be an imaging position, or may be an address, coordinates, a mesh code, or the like that is determined from the image. The determination unit 302 may determine the position or location of each point within the image from the imaging position and the angle of view of the camera 15. The image of the disaster area to be stored in the disaster area DB 311 may be an image transmitted from the drone 10, or may be an image obtained by cutting out a portion that is determined to be damaged within the transmitted image.

The providing unit 303 transmits information on the disaster area to the user terminal 20. The information on the disaster area can include the degree of damage, the position of the disaster area, and images of the disaster area. The user terminal 20 is, for example, a terminal registered in the center server 30 in advance. The timing at which the providing unit 303 transmits the information on the disaster area may be when there is a request from the user terminal 20, or when the disaster area DB 311 is updated by the determination unit 302.

Then, the configuration of the disaster area information to be stored in the disaster area DB 311 will be described based on FIG. 6. FIG. 6 is a diagram illustrating an example of a table configuration of the disaster area DB 311. The disaster area information table has fields of position, image, and degree of damage. Information (e.g., coordinates or a mesh code) on the position (location) of the disaster area is entered into the position field. This position of the disaster area may be an imaging position or a position corresponding to a point or location where a disaster has occurred in an image. Information on the images obtained by taking images of the disaster area is entered into the image field. Information on the degree of damage determined by the determination unit 302 is entered into the damage degree field.

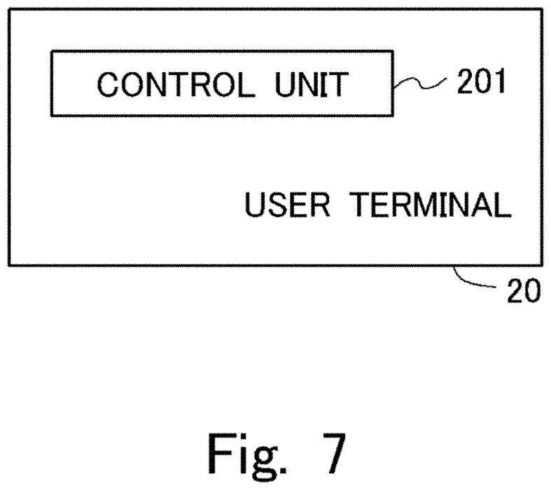

Now, the functions of the user terminal 20 will be described. FIG. 7 is a diagram illustrating an example of a functional configuration of the user terminal 20. The user terminal 20 includes a control unit 201 as its functional component. The processor 21 of the user terminal 20 executes the processing of the control unit 201 by a computer program on the main storage unit 22. For example, the control unit 201 displays on the display 25 the information on the disaster area received from the center server 30. Here, note that the control unit 201 can also request the center server 30 for information on the disaster area.

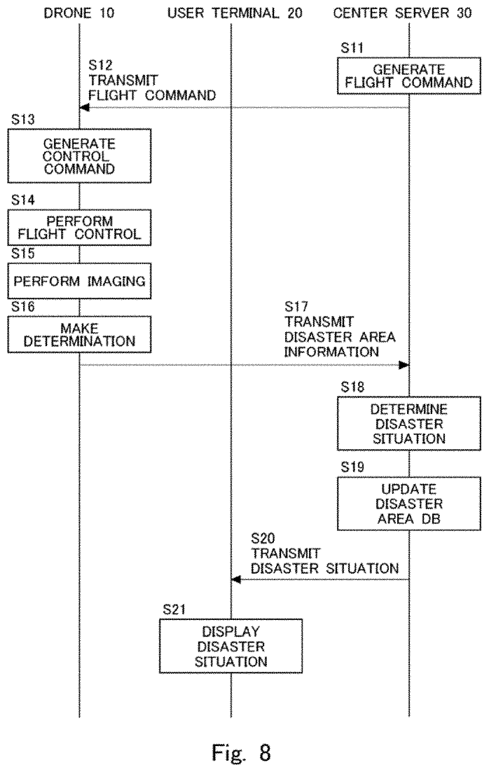

Next, the processing of the system 1 as a whole will be described. FIG. 8 is a sequence diagram of the processing of the system 1. Here, note that the following description will be made on the assumption that reference images have already been stored in the reference image DB 311. The center server 30 generates a flight command for the drone 10 (S11). This flight command is generated so that, for example, the drone 10 performs imaging in a predetermined area in which a possible disaster condition (i.e., a condition where a disaster may occur) has been detected. The predetermined area is, for example, an area in which an earthquake has occurred or an area in which a predetermined amount or more of rain has fallen. The flight command includes information on the predetermined area or information on imaging positions. Also, the flight command may include information on a flight route. After generating the flight command, the center server 30 transmits the flight command to the drone 10 (S12).

The drone 10, which has received the flight command, generates a control command for controlling the drive unit 18 based on the flight command (S13). Here, note that in the example illustrated in FIG. 8, the drone 10 starts flight control after the flight command is transmitted from the center server 30 to the drone 10, but instead of this, when the flight control unit 101 of the drone 10 detects a possible disaster condition (e.g., when an earthquake has occurred or when a predetermined amount or more of rain has fallen), the drone 30 may start an autonomous flight. That is, the drone 10 may start the flight control without an instruction or command from the center server 30. Then, the drone 10 performs the flight control according to the control command, and autonomously moves to each imaging position (S14). When the drone 10 arrives at each imaging position, the drone 10 performs imaging (S15), and further compares each taken image with a reference image stored in the reference image DB 111 to determine whether or not there is a difference of a predetermined value or more between them (S16).

The drone 10 transmits, as disaster area information, images which are each determined to have a difference equal to or greater than the predetermined value, to the center server 30 together with position information (S17). The processing from S14 to S17 is repeatedly executed for each imaging position. The center server 30, which has received the disaster area information, determines a situation of damage based on the received images (S18). The damage situation is determined by analyzing images stored in the disaster area DB 311. Then, the center server 30 updates the disaster area DB 311 (S19). Further, the determination result of the disaster situation is transmitted from the center server 30 to the user terminal 20 (S20). The determination result of the disaster situation may be transmitted in response to a request from the user terminal 20. The user terminal 20, which has received the determination result of the disaster situation, displays information about the disaster situation on the display 25 (S21).

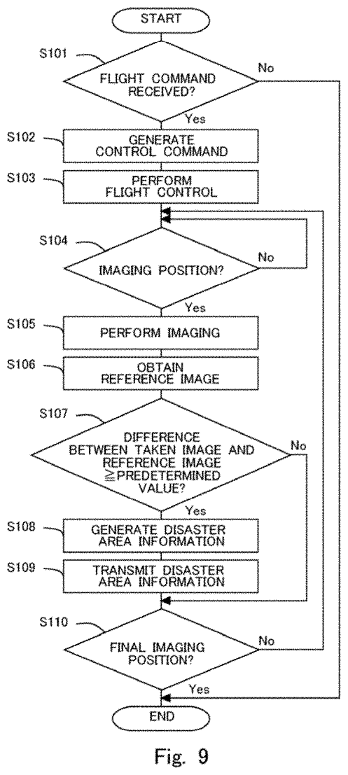

Next, the imaging processing in the drone 10 will be described. The imaging processing is processing corresponding to S13 to S17 described above. FIG. 9 is a flowchart of the imaging processing according to the present embodiment. The imaging processing illustrated in FIG. 9 is executed in the drone 10 at predetermined time intervals.

In step S101, the flight control unit 101 determines whether or not an operation or flight command has been received from the center server 30. Here, note that, alternatively, in step S101, the flight control unit 101 may determine whether or not the condition in which a disaster may occur has been detected. When an affirmative determination is made in step S101, the processing proceeds to step S102, whereas when a negative determination is made, this routine is ended. In step S102, the flight control unit 101 generates a control command in accordance with the flight command. The control command is generated so that, for example, the drone 10 starts from a base station, passes through each imaging position, and then returns to the base station. Here, note that the control command may have been generated in advance according to the predetermined area, and stored in the auxiliary storage unit 13. In addition, the control command may be generated by using a known technique. In step S103, the flight control unit 101 controls the drive unit 18 in accordance with the control command, whereby the flight control is performed. By this flight control, the drone 10 goes around each imaging position.

In step S104, the imaging unit 102 determines whether or not the drone 10 has arrived at an imaging position. For example, the imaging unit 102 determines whether or not the drone 10 has arrived at an imaging position, by comparing the position information obtained by the position information sensor 16 with the information on the imaging position obtained from the user terminal 20 or the center server 30. Note that the flight control unit 101 may perform control so as to take pictures or images under the same condition (e.g., the same altitude and the same orientation) as a reference image at each imaging position, and the imaging unit 102 may determine that each imaging position has been arrived at when this condition is satisfied. When an affirmative determination is made in step S104, the processing proceeds to step S105, whereas when a negative determination is made, the processing of step S104 is executed again.

In step S105, the imaging unit 102 controls the camera 15 to image the surroundings of the drone 10. In step S106, the determination unit 103 obtains a reference image. The reference image corresponds to the imaging position determined in step S104, and is obtained from the reference image DB 111. Then, in step S107, the determination unit 103 compares the image taken in step S105 with the reference image obtained in step S106, and determines whether or not a difference between these images is equal to or greater than the predetermined value. For example, the determination unit 103 compares a feature amount of the taken image with a feature amount of the reference image. The predetermined value has been stored in advance in the auxiliary storage unit 13 as a difference between the feature amounts when a disaster occurs. When an affirmative determination is made in step S107, the processing proceeds to step S108, whereas when a negative determination is made, the processing proceeds to step S110.

In step S108, the determination unit 103 generates disaster area information. The disaster area information includes information about each of the image taken in step S105 and the imaging position determined in step S104. After generating the disaster area information, the determination unit 103 transmits the disaster area information to the center server 30 in step S109.

In step S110, the imaging unit 102 determines whether or not the imaging position determined in step S104 is the final imaging position. That is, it is determined whether or not all necessary images have been taken. The final imaging position may be included in the control command or may be set in step S102, for example. When an affirmative determination is made in step S110, this routine is ended. In this case, when the drone 10 returns to the base station, the flight control ends. On the other hand, when a negative determination is made in step S110, the processing returns to step S104. Then, taking an image at another imaging position is repeatedly executed.

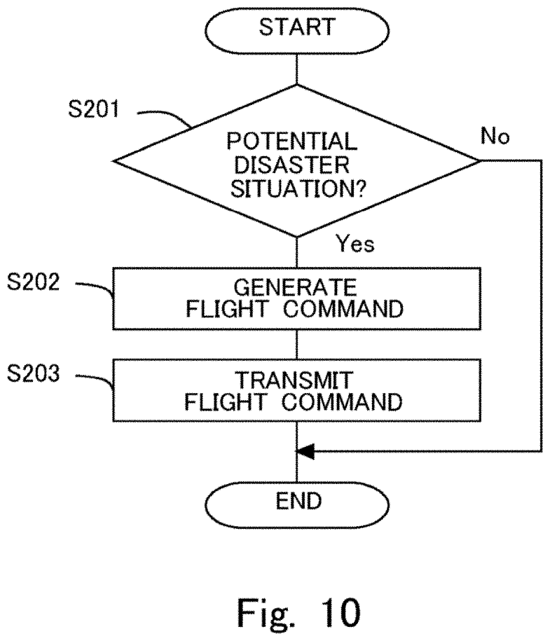

Then, command generation processing in the center server 30 will be described. The command generation processing corresponds to the processing from S11 to S12 described above. FIG. 10 is a flowchart of the command generation processing according to the present embodiment. The command generation processing illustrated in FIG. 10 is executed at predetermined time intervals in the center server 30.

In step S201, the command unit 301 determines whether or not the situation is such that a disaster may occur (i.e., whether or not there is a potential disaster situation). For example, when an earthquake of a predetermined seismic intensity or more has occurred, when a rain in a predetermined amount or more has fallen, when a wind at a predetermined wind speed or more has blown, or when a typhoon has approached within a predetermined distance, it is determined that a disaster may occur. The command unit 301 accesses information by accessing, for example, a server that provides weather information. When an affirmative determination is made in step S201, the processing proceeds to step S202, and when a negative determination is made, this routine is ended.

In step S202, the command unit 301 generates a flight command. The flight command is generated such that an area in which a disaster may occur is set as a predetermined area and the drone 10 can fly through each imaging position in the predetermined area. For example, the predetermined area may be divided into a plurality of meshes, and the center of each mesh may be set as an imaging position. In addition, as another method, locations where disasters have occurred in the past may be searched for in the predetermined area, and positions at which the locations where the disasters have occurred can be taken or imaged may be set as imaging positions. The locations where the disasters have occurred in the past may be stored in the auxiliary storage unit 33 of the center server 30, or may be obtained from an external server, for example. Then, in step S203, the command unit 301 transmits a flight command to the drone 10. Here, note that in the example illustrated in FIG. 10, the flight command is transmitted from the center server 30 to the drone 10, but instead of this, the flight command may be transmitted from the user terminal 20 to the drone 10.

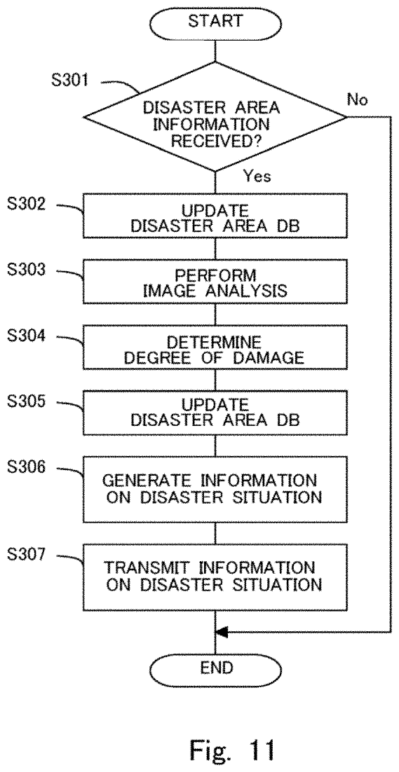

Next, determination processing in the center server 30 will be described. The determination processing corresponds to the processing of S18 to S20 described above. FIG. 11 is a flowchart of the determination processing according to the present embodiment. The determination processing illustrated in FIG. 11 is executed at predetermined time intervals in the center server 30 after the command generation processing illustrated in FIG. 10 is executed.

In step S301, the determination unit 302 determines whether or not the disaster area information has been received from the drone 10. When an affirmative determination is made in step S301, the processing proceeds to step S302, whereas when a negative determination is made, this routine is ended. In step S302, the determination unit 302 updates the position field and the image field of the disaster area DB 311 based on the disaster area information. In step S303, the determination unit 302 analyzes the images included in the received disaster area information. In this image analysis, for example, a situation of damage of houses (e.g., half damage or full damage) or a situation of roads (e.g., no driving in one lane or no driving in both lanes) may be determined. Known techniques can be used for the image analysis.

In step S304, the determination unit 302 determines the degree of damage based on the image analysis performed in step S303. The relation between the result of the image analysis and the degree of damage has been stored in advance in the auxiliary storage unit 33, for example. In step S305, the determination unit 302 updates the disaster area DB 311 by entering the determination result of the step S304 into the damage degree field of the disaster area DB 311. In step S306, the providing unit 303 generates information on the disaster situation. The information on the disaster situation includes the degree of damage, the position of the disaster area, the images of the disaster area, and the like. In step S307, the providing unit 303 transmits the information on the disaster situation generated in step S306 to the user terminal 20.

As described above, according to the present embodiment, it is possible to specify a disaster area and grasp a degree of damage when a disaster has occurred, by using the drone 10 that is autonomously movable.

### Other Embodiments

The above-described embodiment is merely an example, but the present disclosure can be implemented with appropriate modifications without departing from the spirit thereof.

The processing and means (devices, units, etc.) described in the present disclosure can be freely combined and implemented as long as no technical contradiction occurs.

In addition, the processing described as being performed by a single device or unit may be shared and performed by a plurality of devices or units. Alternatively, the processing described as being performed by different devices or units may be performed by a single device or unit. In a computer system, it is possible to flexibly change the hardware configuration (server configuration) that can achieve each function of the computer system. For example, the center server 30 may include some of the functions of the drone 10. For example, the center server 30 may have the functions of the determination unit 101 of the drone 10. Also, for example, some or all of the functions of the center server 30 may be included in the drone 10. For example, the drone 10 may have the functions of the determination unit 302 or the providing unit 303 of the center server 30.

Moreover, in the above-described embodiment, the drone 10 has been described as an example of the moving object, but instead of this, the present invention can be applied to, for example, a vehicle capable of traveling autonomously.

The present disclosure can also be realized by supplying to a computer a computer program in which the functions described in the above-described embodiments are implemented, and reading out and executing the program by means of one or more processors included in the computer. Such a computer program may be provided to a computer by a non-transitory computer readable storage medium connectable to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. A system comprising:
a moving object configured to move autonomously; and
a server;
the moving object including:
an imaging device configured to take images of surroundings of the moving object that moves autonomously;
a storage unit configured to store a reference image, which is an image taken at an imaging position in a predetermined area; and
a controller configured to transmit, to the server, a first image that is an image taken by the imaging device at the imaging position and that is different by a predetermined value or more from the reference image, and information on the position at which the first image has been taken; and
the server being configured to determine, based on the first image received, a situation of damage in the predetermined area.

2. The system according to claim 1, wherein
the storage unit stores information on a plurality of imaging positions and reference images corresponding to the plurality of imaging positions, respectively, and;
the controller controls autonomous movement of the moving object so that the moving object travels around the imaging positions stored in the storage unit.

3. The system according to claim 1, wherein
the server transmits information on a plurality of imaging positions to the moving object.

4. The system according to claim 1, wherein
the server generates a command to move the moving object so as to go around a plurality of imaging positions, and transmits the command thus generated to the moving object.

5. The system according to claim 4, wherein
the server generates the command when a situation in which a disaster occurs is detected.

6. The system according to claim 1, wherein
the imaging position is a position associated with a place where a disaster has occurred in the past.

7. The system according to claim 1, further comprising:
a user terminal to be used by a user;
wherein the server transmits the determined situation of damage in the predetermined area to the user terminal.

8. The system according to claim 1, wherein
the server determines the situation of damage in the predetermined area by performing an image analysis of the first image.

9. The system according to claim 1, wherein
the moving object is a drone.

10. A moving object comprising:
an imaging device configured to take images of surroundings of the moving object that moves autonomously;
a storage unit configured to store a reference image, which is an image taken at an imaging position in a predetermined area; and
a controller configured to perform transmitting, to a server, a first image that is an image taken by the imaging device at the imaging position and that is different by a predetermined value or more from the reference image, and information on the position at which the first image has been taken.

11. The moving object according to claim 10, wherein
the storage unit stores information on a plurality of imaging positions and reference images corresponding to the plurality of imaging positions, respectively, and;
the controller controls autonomous movement of the moving object so that the moving object travels around the imaging positions stored in the storage unit.

12. The moving object according to claim 10, wherein
the moving object receives, from the server, information on a plurality of imaging positions.

13. The moving object according to claim 10, wherein
the imaging position is a position associated with a place where a disaster has occurred in the past.

14. The moving object according to claim 10, wherein
the moving object moves to the imaging position when a situation in which a disaster occurs is detected.

15. An information processing apparatus including a controller configured to perform:
receiving a first image that is an image taken by an autonomously moving object at the same position as a reference image, which is an image taken at an imaging position within a predetermined area, and that is different by a predetermined value or more from the reference image, and information on the position at which the first image has been taken; and
determining, based on the first image thus received, a situation of damage in the predetermined area.

16. The information processing apparatus according to claim 15, wherein
the controller transmits information on a plurality of imaging positions to the moving object.

17. The information processing apparatus according to claim 15, wherein
the controller generates a command to move the moving object so as to go around a plurality of imaging positions, and transmits the command thus generated to the moving object.

18. The information processing apparatus according to claim 17, wherein
the controller generates the command when a situation in which a disaster occurs is detected.

19. The information processing apparatus according to claim 15, wherein
the imaging position is a position associated with a place where a disaster has occurred in the past.

20. The information processing apparatus according to claim 15, wherein
the controller transmits the determined situation of damage in the predetermined area to a user terminal.
